(19) United States
(12) Patent Application Publication
(10) Pub. No.: US 2026/0284603 A1
(43) Pub. Date: Sep. 24, 2026

(54) TREATED MICROPOROUS MEMBRANE

(71) Applicant: PPG INDUSTRIES OHIO, INC., Cleveland, OH (US)

(72) Inventor: Qunhui Guo, Pittsburgh, PA (US)

(73) Assignee: PPG INDUSTRIES OHIO, INC., Cleveland, OH (US)

(21) Appl. No.: 18/873,934

(22) PCT Filed: May 17, 2023
(86) PCT No.: PCT/US2023/067097

§ 371 Date: Dec. 11, 2024

Related U.S. Application Data
(60) Provisional application No. 63/366,370, filed on Jun. 14, 2022.

(51) Int. Cl. B01D 69/14; B01D 61/14; B01D 67/00; B01D 71/02

(52) U.S. Cl. CPC B01D 69/1411; B01D 61/147; B01D 67/0088; B01D 67/00933; B01D 71/024; B01D 2325/028

(57) ABSTRACT

Methods for treating a surface of a microporous membrane are provided, comprising: contacting the membrane with a treatment composition to form a silane-treated membrane; subjecting the silane-treated membrane to conditions sufficient to effect condensation between filler in the membrane and acrylic polymer in the treatment composition; contacting the silane-treated membrane with an amine-functional polysaccharide dispersed in an acidic aqueous medium to form a polysaccharide-treated membrane; contacting the polysaccharide-treated membrane with an aqueous acid; and contacting the polysaccharide-treated membrane with an amine-functional alkoxysilane to form a hydrogel layer on the membrane. Also provided is a method for treating a filtration device, the device comprising a microporous membrane and an acid-functional acrylic layer on the membrane. The present invention is further directed to a treated microporous membrane comprising: a microporous membrane; an acrylic layer on the microporous membrane; and a hydrogel layer on at least one surface of the acrylic layer.

### FIELD OF THE DISCLOSURE

The present disclosure relates to a method for treating the surface of a microporous membrane and to a treated microporous membrane. The present disclosure also relates to a method for treating a filtration device and to a treated filtration device.

### BACKGROUND

Billions of gallons of co-produced water are drawn up by oil and gas wells each year in the United States. Natural “oil” from a well is actually a multiphase emulsion of oil, water, and gas. Generally, all three fluids are found in every hydrocarbon well and well effluent. For example, bilge water contains a high hydrocarbon concentration with a wide range of carbon numbers. Bilge water is often a mixture of washing chemicals, rust, sewage, boiler water chemicals, lubrication and hydraulic oil, foaming liquids, grey water, metals, soot, bacteria, dust, etc.

Because of its value and because of environmental concerns, oil needs to be separated from these effluents. This is usually done through gravitational settling in large tanks, which requires capital and significant space that is not always available onsite. Gas is separated easily in a mechanical separator or by pressure reduction within storage containers. In the case of heavy oils and many emulsified fluid systems, the raw fluids are heated to change the density of the oil and water by heating off lighter ends and essentially agitating their molecular structures so that these fluids can more easily separate. Water then is a byproduct.

Filled microporous membranes are known to be low cost, efficient, and environmentally friendly separation media for the separation of oil from byproduct water such as bilge water and other effluents mentioned above. However, as with most filtration media, over a period of time the filtration membranes can become fouled with residual oil and other contaminants. Such fouling can decrease the flux rates and thus reduce the efficiency of the filter devices. It would be desirable to provide a microporous membrane for use as an extended life filtration medium able to operate at high pressures, having improved anti-fouling properties and good oil retention rates, while maintaining a high flux rate.

### SUMMARY OF THE DISCLOSURE

A method for treating a surface of a microporous membrane is provided, the membrane comprising an organic thermoplastic matrix; finely divided particulate, substantially water-insoluble inorganic filler distributed throughout the matrix; and a network of interconnecting pores communicating throughout the microporous membrane. The method comprises in sequence: (1) contacting at least one surface of the membrane with a treatment composition to form a silane-treated membrane, the treatment composition comprising: (a) an acrylic polymer prepared from a mixture of vinyl monomers comprising: (i) a (meth)acrylic acid monomer and (ii) a silane-functional acrylic monomer; and (b) a base, where the acrylic polymer is in contact with the filler present in the matrix; (2) subjecting the silane-treated membrane formed in (1) to conditions sufficient to effect a condensation reaction between the filler and the acrylic polymer; (3) contacting at least one surface of the silane-treated membrane with a dispersion comprising an amine-functional polysaccharide dispersed in an aqueous medium containing an organic acid, to form a polysaccharide-treated membrane; (4) contacting at least one surface of the polysaccharide-treated membrane formed in (3) with an aqueous acid; and (5) contacting the polysaccharide-treated membrane with an amine-functional alkoxysilane to form a polysaccharide hydrogel layer on the membrane. A treated microporous membrane prepared by the method is also provided.

A method for treating a filtration device, the filtration device comprising a microporous membrane is additionally provided, the microporous membrane comprising an organic thermoplastic matrix; finely divided particulate, substantially water-insoluble inorganic filler distributed throughout the matrix; a network of interconnecting pores communicating throughout the microporous membrane, and an acid-functional acrylic layer on at least one surface of the microporous membrane, wherein the acid-functional acrylic layer is bonded to the filler via siloxane functional groups. The method comprises in sequence: (1) contacting at least one surface of the acid-functional acrylic layer on the microporous membrane with a dispersion comprising an amine-functional polysaccharide dispersed in an aqueous medium containing an organic acid, to form a polysaccharide-treated membrane; (2) contacting at least one surface of the polysaccharide-treated membrane formed in (1) with an aqueous acid; and (3) contacting the polysaccharide-treated membrane with an amine-functional alkoxysilane to form a polysaccharide hydrogel layer on the membrane. The present disclosure is also directed to a treated filtration device prepared by the method.

The present disclosure is further directed to a treated microporous membrane comprising: (1) a microporous membrane comprising an organic thermoplastic matrix; finely divided particulate, substantially water-insoluble inorganic filler distributed throughout the matrix; and a network of interconnecting pores communicating throughout the microporous membrane; (2) an acrylic layer on at least one surface of the microporous membrane, wherein the acrylic layer is bonded to the filler via siloxane functional groups; and (3) a hydrogel layer on at least one surface of the acrylic layer, wherein the hydrogel layer is formed from an amine-functional polysaccharide and an amine-functional alkoxysilane.

### DESCRIPTION

For purposes of the following detailed description, it is to be understood that various alternative variations and step sequences are assumed, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. Further, in this application, the use of “a” or “an” means “at least one” unless specifically stated otherwise. For example, “an” additive, “a” silica, and the like refer to one or more of these items. Also, as used herein, the term “polymer” is meant to refer to prepolymers, oligomers, and both homopolymers and copolymers. The term “resin” is used interchangeably with “polymer.”

As used herein, the transitional term “comprising” (and other comparable terms, e.g., “containing” and “including”) is “open-ended” and is used in reference to compositions, methods, and respective component(s) thereof that are essential, yet open to the inclusion of unspecified matter. The term “consisting essentially of” refers to those component(s) required for a given example and permits the presence of component(s) that do not materially affect the properties or functional characteristic(s) of that example. The term “consisting of” refers to compositions and methods that are exclusive of any other component not recited in that description of the example. Note further that the term “comprising” nevertheless encompasses the narrower terms “consisting essentially of” and “consisting of”.

The present disclosure is directed to a method for treating a surface of a microporous membrane, the membrane comprising an organic thermoplastic matrix; finely divided particulate, substantially water-insoluble inorganic filler distributed throughout the matrix; and a network of interconnecting pores communicating throughout the microporous membrane. The method includes the following steps: (1) contacting at least one surface of the membrane with a treatment composition to form a silane-treated membrane, the treatment composition comprising: (a) an acrylic polymer prepared from a mixture of vinyl monomers comprising: (i) a (meth)acrylic acid monomer and (ii) a silane-functional acrylic monomer; and (b) a base in a sufficient quantity to accomplish at least 100% neutralization of the (meth)acrylic acid monomer, wherein the acrylic polymer is in contact with the filler present in the matrix; (2) subjecting the silane-treated membrane formed in (1) to conditions sufficient to effect a condensation reaction between the filler and the acrylic polymer; (3) contacting at least one surface of the silane-treated membrane with a dispersion comprising an amine-functional polysaccharide dispersed in an aqueous medium containing an organic acid, to form a polysaccharide-treated membrane; (4) contacting at least one surface of the polysaccharide-treated membrane formed in (3) with an aqueous acid; and (5) contacting the polysaccharide-treated membrane with an amine-functional alkoxysilane to form a polysaccharide hydrogel layer on the membrane.

As used herein, “microporous material” or “microporous membrane” or “microporous sheet” means a material having a network of interconnecting pores, wherein, on a treatment-free, coating-free, printing ink-free, impregnant-free, and pre-bonding basis, the pores have a volume average diameter ranging from 0.001 to 1.0 micrometer, determined as described below, and constitute at least 5 percent by volume of the microporous material as discussed herein below.

The organic thermoplastic matrix can comprise any of a number of known polymeric, typically polyolefinic, materials known in the art. For example, the organic thermoplastic matrix may comprise polyolefin, polyetherketone, polyvinylidene fluoride (PVDF), polysulfone, and/or polyethersulfone. In some instances, a different polymer derived from at least one ethylenically unsaturated monomer may be used in combination with polyolefinic polymers. Suitable examples of such polyolefinic polymers can include, but are not limited to, polymers derived from ethylene, propylene, and/or butene, such as polyethylene, polypropylene, and polybutene. High density and/or ultrahigh molecular weight polyolefins as known and defined in the art, such as high-density polyethylene (HDPE), are also suitable. The polyolefin matrix also can comprise a copolymer, for example, a copolymer of ethylene and butene or a copolymer of ethylene and propylene. Note that the phrase “and/or” when used in a list is meant to encompass alternative examples including each individual component in the list as well as any combination of components. For example, the list “A, B, and/or C” is meant to encompass seven separate examples that include A, or B, or C, or A+B, or A+C, or B+C, or A+B+C.

Non-limiting examples of ultrahigh molecular weight (UHMW) polyolefin can include essentially linear UHMW polyethylene (PE) or polypropylene (PP). Inasmuch as UHMW polyolefins are not thermoset polymers having an infinite molecular weight, they are technically classified as thermoplastic materials.

The ultrahigh molecular weight polypropylene can comprise essentially linear ultrahigh molecular weight isotactic polypropylene. Often, the degree of isotacticity of such polymer is at least 95 percent, e.g., at least 98 percent.

While there is no particular restriction on the upper limit of the intrinsic viscosity of the UHMW polyethylene, in one non-limiting example, the intrinsic viscosity can range from at least 6 deciliters/gram, or at least 7 deciliters/gram, or at least 18 deciliters/gram, to at most 50 deciliters/gram, or at most 45 deciliters/gram, or at most 18 deciliters/gram, or at most 16 deciliters/gram. Thus, the intrinsic viscosity of the UHMW may be, for example, 6 to 50 deciliters/gram, or 6 to 45 deciliters/gram, or 6 to 18 deciliters/gram, or 6 to 16 deciliters/gram, or 7 to 50 deciliters/gram, or 7 to 45 deciliters/gram, or 7 to 18 deciliters/gram, or 7 to 16 deciliters/gram, or 18 to 50 deciliters/gram, or 18 to 45 deciliters/gram.

For purposes of the present disclosure, intrinsic viscosity is determined by extrapolating to zero concentration the reduced viscosities or the inherent viscosities of several dilute solutions of the UHMW polyolefin where the solvent is freshly distilled decahydronaphthalene to which 0.2 percent by weight, 3,5-di-tert-butyl-4-hydroxyhydrocinnamic acid, neopentanetetrayl ester [CAS Registry No. 6683-19-8] has been added. The reduced viscosities or the inherent viscosities of the UHMW polyolefin are ascertained from relative viscosities obtained at 135° C. using an Ubbelohde No. 1 viscometer in accordance with the general procedures of ASTM D 4020-81, except that several dilute solutions of differing concentration are employed.

The nominal molecular weight of UHMW polyethylene is empirically related to the intrinsic viscosity of the polymer in accordance with the following equation:

$$M = 5.37 \times 1 {{0}^{4} [ η ]}^{1.37}$$

wherein M is the nominal molecular weight and [η] is the intrinsic viscosity of the UHMW polyethylene expressed in deciliters/gram. Similarly, the nominal molecular weight of UHMW polypropylene is empirically related to the intrinsic viscosity of the polymer according to the following equation:

$$M = 8.88 \times {{10}^{4} [ η ]}^{1.25}$$

wherein M is the nominal molecular weight and [η] is the intrinsic viscosity of the UHMW polypropylene expressed in deciliters/gram.

A mixture of substantially linear ultrahigh molecular weight polyethylene and lower molecular weight polyethylene can be used. For example, the UHMW polyethylene can have an intrinsic viscosity of at least 10 deciliters/gram, and the lower molecular weight polyethylene can have an ASTM D 1238-86 Condition E melt index of less than 50 grams/10 minutes, e.g., less than 25 grams/10 minutes, such as less than 15 grams/10 minutes, and an ASTM D 1238-86 Condition F melt index of at least 0.1 gram/10 minutes, e.g., at least 0.5 gram/10 minutes, such as at least 1.0 gram/10 minutes. The amount of UHMW polyethylene used (as weight percent) in this example is described in column 1, line 52 to column 2, line 18 of U.S. Pat. No. 5,196,262, which disclosure is incorporated herein by reference. More particularly, the weight percent of UHMW polyethylene used is described in relation to FIG. 6 of U.S. Pat. No. 5,196,262; namely, with reference to the polygons ABCDEF, GHCI or JHCK of FIG. 6, which FIGURE is incorporated herein by reference. For example, the weight percent of the ultrahigh molecular weight polyethylene in the total polyethylene of the matrix may range from 3 to 60 percent by weight, such as from 10 to 48 percent by weight,

The nominal molecular weight of the lower molecular weight polyethylene (LMWPE) is lower than that of the UHMW polyethylene. LMWPE is a thermoplastic material and many different types are known. One method of classification is by density, expressed in grams/cubic centimeter and rounded to the nearest thousandth, in accordance with ASTM D 1248-84 (Reapproved 1989). Non-limiting examples of the densities are found in the following table.

| | | Density |
|---|---|---|
| Type | Abbreviation | (g/cm³) |
| Low | LDPE | 0.910- |
| Density PE | | 0.925 |
| Medium | MDPE | 0.926- |
| Density PE | | 0.940 |
| High | HDPE | 0.941- |
| Density PE | | 0.965 |

The UHMWPE and the LMWPE may together constitute at least 65 percent by weight, e.g., at least 85 percent by weight, of the polyolefin polymer of the microporous material. Also, the UHMWPE and LMWPE together may constitute substantially 100 percent by weight of the polyolefin polymer of the microporous material. In some examples, the UHMWPE may constitute substantially 100% (e.g., at least 99%) by weight of the polyolefin polymer of the microporous material.

Typically, the organic thermoplastic matrix can comprise a polyolefin comprising ultrahigh molecular weight polyethylene, ultrahigh molecular weight polypropylene, high density polyethylene, high density polypropylene, or mixtures thereof.

If desired, other thermoplastic organic polymers also may be present in the matrix of the microporous material provided that their presence does not materially affect the properties of the microporous material substrate in an adverse manner. The amount of the other thermoplastic polymer which may be present depends upon the nature of such polymer. Non-limiting examples of thermoplastic organic polymers that optionally may be present in the matrix of the microporous material include low density polyethylene, high density polyethylene, poly(tetrafluoroethylene), polypropylene, copolymers of ethylene and propylene, copolymers of ethylene and acrylic acid, or copolymers of ethylene and methacrylic acid. If desired, all or a portion of the carboxyl groups of carboxyl-containing copolymers can be neutralized with sodium, zinc, or the like. Generally, the microporous material comprises at least 70 percent by weight of UHMW polyolefin, based on the weight of the matrix. In a non-limiting example, the above-described other thermoplastic organic polymer are substantially absent from the matrix of the microporous material.

The microporous membranes further comprise finely divided, particulate, substantially water-insoluble inorganic filler distributed throughout the matrix.

The inorganic filler can include any of a number of inorganic fillers known in the art, provided that the filler is capable of undergoing a condensation reaction with the acrylic polymer present in the treatment composition which is applied to the membrane in (1). The filler should be finely divided and substantially water insoluble to permit uniform distribution throughout the polyolefinic polymeric matrix during manufacture of the microporous material. Generally, the inorganic filler is selected from the group consisting of silica, alumina, calcium oxide, zinc oxide, magnesium oxide, titanium oxide, zirconium oxide, and mixtures thereof.

The finely divided substantially water-insoluble filler may be in the form of ultimate particles, aggregates of ultimate particles, or a combination of both. At least 90 percent by weight of the filler used in preparing the microporous material has gross particle sizes in the range of from 5 to 40 micrometers, as determined by the use of a laser diffraction particle size instrument, LS 13320 from Beckman Coulter, according to manufacturer's instructions. The device is capable of measuring particle diameters as small as 0.04 micron, in general, using a laser with a wavelength of 750 nm to size particles with diameters from 0.04 mm to 2000 mm. The particles scatter the light in patterns determined by their sizes, and arrays of photodetectors detect and measure the scattered light. The photodetectors are scanned and their outputs converted to digital values which are transmitted to the computer for calculation. Typically, at least 90 percent by weight of the filler has gross particle sizes in the range of from 10 to 30 micrometers. The sizes of the filler agglomerates may be reduced during processing of the ingredients used to prepare the microporous material. Accordingly, the distribution of gross particle sizes in the microporous material may be smaller than in the raw filler itself.

As mentioned previously, the filler particles are substantially water-insoluble, and also can be substantially insoluble in any organic processing liquid used to prepare the microporous material. In other words, the composition of the filler particles facilitates retention of the filler in the microporous material.

In addition to the fillers, other finely divided particulate substantially water-insoluble materials optionally may also be employed. Non-limiting examples of such optional materials can include carbon black, charcoal, graphite, iron oxide, copper oxide, antimony oxide, molybdenum disulfide, zinc sulfide, barium sulfate, strontium sulfate, calcium carbonate, or magnesium carbonate. In one non-limiting example, silica and any one or more of the aforementioned optional filler materials can comprise the filler.

The filler typically has a high surface area allowing the filler to carry much of the processing plasticizer used to form the microporous material. The surface area of the filler particles can range from at least 20 square meters per gram, or at least 25 square meters per gram, to at most 900 square meters per gram, or at most 850 square meters per gram; e. g., from 20 to 900 square meters per gram, or from 20 to 850 square meters per gram, or from 25 to 900 square meters per gram, or from 25 to 850 square meters per gram, as determined by the Brunauer, Emmett, Teller (BET) method according to ASTM C 819-77 using nitrogen as the adsorbate but modified by outgassing the system and the sample for one hour at 130° C. Prior to nitrogen sorption, filler samples are dried by heating to 160° C. in flowing nitrogen (PS) for 1 hour.

In a particular example, the inorganic filler comprises silica, for example, precipitated silica, silica gel, or fumed silica.

Silica gel is generally produced commercially by acidifying an aqueous solution of a soluble metal silicate, e.g., sodium silicate at low pH with acid. The acid employed is generally a strong mineral acid, such as sulfuric acid or hydrochloric acid, although carbon dioxide can be used. Inasmuch as there is essentially no difference in density between the gel phase and the surrounding liquid phase while the viscosity is low, the gel phase does not settle out, that is to say, it does not precipitate. Consequently, silica gel may be described as a non-precipitated, coherent, rigid, three-dimensional network of contiguous particles of colloidal amorphous silica. The state of subdivision ranges from large, solid masses to submicroscopic particles, and the degree of hydration from almost anhydrous silica to soft gelatinous masses containing on the order of 100 parts of water per part of silica by weight.

Precipitated silica generally is produced commercially by combining an aqueous solution of a soluble metal silicate, ordinarily alkali metal silicate such as sodium silicate, and an acid so that colloidal particles of silica will grow in a weakly alkaline solution and be coagulated by the alkali metal ions of the resulting soluble alkali metal salt. Various acids may be used, including but not limited to mineral acids. Non-limiting examples of acids that can be used include hydrochloric acid and sulfuric acid, but carbon dioxide can also be used to produce precipitated silica. In the absence of a coagulant, silica is not precipitated from solution at any pH. In a non-limiting example, the coagulant used to effect precipitation of silica may be the soluble alkali metal salt produced during formation of the colloidal silica particles, or it may be an added electrolyte, such as a soluble inorganic or organic salt, or it may be a combination of both.

Precipitated silica can be described as precipitated aggregates of ultimate particles of colloidal amorphous silica that have not at any point existed as macroscopic gel during the preparation. The sizes of the aggregates and the degree of hydration may vary widely. Precipitated silica powders differ from silica gels that have been pulverized in that the precipitated silica powders generally have a more open structure, that is, a higher specific pore volume, than do silica gels. However, the specific surface area of precipitated silica, as measured by the Brunauer, Emmet, Teller (BET) method using nitrogen as the adsorbate, is often lower than that of silica gel.

Many different precipitated silicas can be employed as the filler used to prepare the microporous material. Precipitated silicas are well-known commercial materials, and processes for producing them are described in detail in many United States patents, including U.S. Pat. Nos. 2,940,830 and 4,681,750. The average ultimate particle size (irrespective of whether or not the ultimate particles are agglomerated) of precipitated silicas used is generally less than 0.1 micrometer, e.g., less than 0.05 micrometer or less than 0.03 micrometer, as determined by transmission electron microscopy. Non-limiting examples of suitable precipitated silicas include those sold under the HI-SIL tradename by PPG (Pittsburgh, PA).

The inorganic filler particles can constitute at least 10 percent by weight of the microporous membrane, or at least 25 percent by weight, or at least 30 percent by weight, or at least 40 percent by weight, or at least 50 percent by weight, or at least 60 percent by weight, and at most 90 percent by weight, or at most to 85 percent by weight of the microporous membrane. For example, such filler particles can constitute from 25 to 90 percent by weight, or 25 to 85 percent by weight, or 30 to 90 percent by weight, or 30 to 85 percent by weight, or 40 to 90 percent by weight, or 40 to 85 percent by weight, or 50 to 90 percent by weight, or 50 to 85 percent by weight, or 60 to 90 percent by weight, or 60 to 85 percent by weight, of the microporous membrane. The filler typically is present in the microporous membrane in an amount ranging from 50 percent to 85 percent by weight of the microporous membrane. Often, the weight ratio of filler to polyolefin in the microporous material ranges from 0.5:1 to 10:1, such as 1.7:1 to 3.5:1. Alternatively, the weight ratio of filler to polyolefin in the microporous material may be greater than 4:1. It is contemplated that higher levels of filler may be employed, as such levels of filler would provide higher surface area available for condensation reactions with the treatment compositions.

The microporous material used in the disclosed membrane further comprises a network of interconnecting pores communicating throughout the microporous material.

On a treatment-free, coating free, or impregnant-free basis, such pores can make up at least 5 percent by volume, or at least 15 percent by volume, or at least 20 percent by volume, or at least 25 percent by volume, or at least 35 percent by volume, or at least 45 percent by volume, and at most 95 percent by volume, or at most 75 percent by volume. Thus, the pores can make up 5 to 95 percent by volume, or 15 to 95 percent by volume, or 20 to 95 percent by volume, or 25 to 95 percent by volume, or 35 to 95 percent by volume, or 45 to 95 percent by volume, or 5 to 70 percent by volume, or 15 to 70 percent by volume, or 20 to 70 percent by volume, or 25 to 70 percent by volume, or 35 to 70 percent by volume, or 45 to 70 percent by volume of the microporous material. Often, the pores comprise at least 35 percent by volume, or even at least 45 percent by volume of the microporous material. Such high porosity provides higher surface area throughout the microporous material, which in turn facilitates removal of contaminants from a fluid stream and higher flux rates of a fluid stream through the membrane.

As used herein and in the claims, the porosity (also known as void volume) of the microporous material, expressed as percent by volume, is determined according to the following equation:

$$Porosity = 100 [ 1 - {d}_{1} / {d}_{2} ]$$

wherein d₁ is the density of the sample, which is determined from the sample weight and the sample volume as ascertained from measurements of the sample dimensions, and d₂ is the density of the solid portion of the sample, which is determined from the sample weight and the volume of the solid portion of the sample. The volume of the solid portion of the sample is determined using a Quantachrome Stereopycnometer (Quantachrome Corporation (Boynton Beach, FL)) in accordance with the accompanying operating manual.

Porosity also can be measured using a Gurley Densometer, model 4340, manufactured by GPI Gurley Precision Instruments (Troy, NY). The porosity values reported are a measure of the rate of air flow through a sample or its resistance to an air flow through the sample. The unit of measure for this method is a “Gurley second” and represents the time in seconds to pass 100 cc of air through a 1 inch square area using a pressure differential of 4.88 inches of water. Lower values equate to less air flow resistance (more air is allowed to pass freely). The measurements are completed using the procedure listed in the manual for MODEL 4340 Automatic Densometer.

The volume average diameter of the pores of the microporous material can be determined by mercury porosimetry using an Autopore III porosimeter (Micromeritics, Inc. (Norcross, GA)) in accordance with the accompanying operating manual. The volume average pore radius for a single scan is automatically determined by the porosimeter. In operating the porosimeter, a scan is made in the high pressure range (from 138 kilopascals absolute to 227 megapascals absolute). If approximately 2 percent or less of the total intruded volume occurs at the low end (from 138 to 250 kilopascals absolute) of the high pressure range, the volume average pore diameter is taken as twice the volume average pore radius determined by the porosimeter. Otherwise, an additional scan is made in the low pressure range (from 7 to 165 kilopascals absolute) and the volume average pore diameter is calculated according to the equation:

$$d = 2 [ {v}_{1} {r}_{1} / {w}_{1} + {v}_{2} {r}_{2} / {w}_{2} ] / [ {v}_{1} / {w}_{1} + {v}_{2} / {w}_{2} ]$$

wherein d is the volume average pore diameter, v₁ is the total volume of mercury intruded in the high pressure range, v₂ is the total volume of mercury intruded in the low pressure range, r₁ is the volume average pore radius determined from the high pressure scan, r₂ is the volume average pore radius determined from the low pressure scan, w₁ is the weight of the sample subjected to the high pressure scan, and w₂ is the weight of the sample subjected to the low pressure scan.

In the course of determining the volume average pore diameter of the above procedure, the maximum pore radius detected is sometimes noted. This is taken from the low-pressure range scan, if run; otherwise, it is taken from the high pressure range scan. The maximum pore diameter is twice the maximum pore radius. Inasmuch as some production or treatment steps, e.g., coating processes, printing processes, impregnation processes and/or bonding processes, can result in the filling of at least some of the pores of the microporous material, and since some of these processes irreversibly compress the microporous material, the parameters in respect of porosity, volume average diameter of the pores, and maximum pore diameter are determined for the microporous material prior to the application of one or more of such production or treatment steps.

To prepare the disclosed microporous materials, filler, an organic thermoplastic matrix such as a polyolefin polymer (typically in solid form such as powder or pellets), processing plasticizer, and minor amounts of lubricant and antioxidant are mixed until a substantially uniform mixture is obtained. The weight ratio of filler to polymer employed in forming the mixture is essentially the same as that of the microporous material substrate to be produced. The mixture, together with additional processing plasticizer, is introduced to the heated barrel of a screw extruder. Attached to the extruder is a die, such as a sheeting die, to form the desired end shape.

In an exemplary manufacturing process, when the material is formed into a sheet or film, a continuous sheet or film formed by a die is forwarded to a pair of heated calender rolls acting cooperatively to form a continuous sheet of lesser thickness than the continuous sheet exiting from the die. The final thickness may depend on the desired end-use application. The microporous material may have a thickness ranging from 0.7 to 18 mil (17.8 to 457.2 microns), such as 0.7 to 15 mil (17.8 to 381 microns), or 1 to 10 mil (25.4 to 254 microns), or 5 to 10 mil (127 to 254 microns).

Optionally, the sheet exiting the calendar rolls may then be stretched in at least one stretching direction above the elastic limit. Stretching may alternatively take place during or immediately after exiting from the sheeting die or during calendaring, or multiple times during the manufacturing process. Stretching may take place before extraction, after extraction, or both. Additionally, stretching may take place during the application of the pre-treatment composition and/or treatment composition, described in more detail below. Stretched microporous material substrate may be produced by stretching the intermediate product in at least one stretching direction above the elastic limit. Usually, the stretch ratio is at least 1.2. In many cases, the stretch ratio is at least 1.5. Usually it is at least 2. Frequently, the stretch ratio is in the range of from 1.2 to 15. Often, the stretch ratio is in the range of from 1.5 to 10. Usually, the stretch ratio is in the range of from 2 to 6.

The temperatures at which stretching is accomplished may vary widely. Stretching may be accomplished at ambient room temperature, but usually elevated temperatures are employed. The intermediate product may be heated by any of a wide variety of techniques prior to, during, and/or after stretching. Examples of these techniques include radiative heating, such as that provided by electrically heated or gas fired infrared heaters; convective heating, such as that provided by recirculating hot air; and conductive heating, such as that provided by contact with heated rolls. The temperatures which are measured for temperature control purposes may vary according to the apparatus used and personal preference. For example, temperature-measuring devices may be placed to ascertain the temperatures of the surfaces of infrared heaters, the interiors of infrared heaters, the air temperatures of points between the infrared heaters and the intermediate product, the temperatures of circulating hot air at points within the apparatus, the temperature of hot air entering or leaving the apparatus, the temperatures of the surfaces of rolls used in the stretching process, the temperature of heat transfer fluid entering or leaving such rolls, or film surface temperatures. In general, the temperature or temperatures are controlled such that the intermediate product is stretched about evenly so that the variations, if any, in film thickness of the stretched microporous material are within acceptable limits and so that the amount of stretched microporous material outside of those limits is acceptably low. It will be apparent that the temperatures used for control purposes may or may not be close to those of the intermediate product itself since they depend upon the nature of the apparatus used, the locations of the temperature-measuring devices, and the identities of the substances or objects whose temperatures are being measured.

In view of the locations of the heating devices and the line speeds usually employed during stretching, gradients of varying temperatures may or may not be present through the thickness of the intermediate product. Also, because of such line speeds, it is impracticable to measure these temperature gradients. The presence of gradients of varying temperatures, when they occur, makes it unreasonable to refer to a singular film temperature. Accordingly, film surface temperatures, which can be measured, are best used for characterizing the thermal condition of the intermediate product.

The film surface temperatures at which stretching is accomplished may vary widely, but in general they are such that the intermediate product is stretched about evenly, as explained above. In most cases, the film surface temperatures during stretching are in the range of from 20° C. to 220° C. Often, such temperatures are in the range of from 50° C. to 200° C., such as from 75° C. to 180° C.

Stretching may be accomplished in a single step or a plurality of steps as desired. For example, when the intermediate product is to be stretched in a single direction (uniaxial stretching), the stretching may be accomplished by a single stretching step or a sequence of stretching steps until the desired final stretch ratio is attained. Similarly, when the intermediate product is to be stretched in two directions (biaxial stretching), the stretching can be conducted by a single biaxial stretching step or a sequence of biaxial stretching steps until the desired final stretch ratios are attained. Biaxial stretching may also be accomplished by a sequence of one of more uniaxial stretching steps in one direction and one or more uniaxial stretching steps in another direction. Biaxial stretching steps where the intermediate product is stretched simultaneously in two directions and uniaxial stretching steps may be conducted in sequence in any order. Stretching in more than two directions is within contemplation. It may be seen that the various permutations of steps are quite numerous. Other steps, such as cooling, heating, sintering, annealing, reeling, unreeling, and the like, may optionally be included in the overall process as desired.

Various types of stretching apparatus are well known and may be used to accomplish stretching of the intermediate product. Uniaxial stretching is usually accomplished by stretching between two rollers, wherein the second or downstream roller rotates at a greater peripheral speed than the first or upstream roller. Uniaxial stretching can also be accomplished on a standard tentering machine. Biaxial stretching may be accomplished by simultaneously stretching in two different directions on a tentering machine. More commonly, however, biaxial stretching is accomplished by first uniaxially stretching between two differentially rotating rollers as described above, followed by either uniaxially stretching in a different direction using a tenter machine or by biaxially stretching using a tenter machine. The most common type of biaxial stretching is where the two stretching directions are approximately at right angles to each other. In most cases where the continuous sheet is being stretched, one stretching direction is at least approximately parallel to the long axis of the sheet (machine direction) and the other stretching direction is at least approximately perpendicular to the machine direction and is in the plane of the sheet (transverse direction).

Stretching the sheets prior to extraction of the processing plasticizer allows for thinner films with larger pore sizes than in microporous materials conventionally processed. It is also believed that stretching of the sheets prior to extraction of the processing plasticizer minimizes thermal shrinkage after processing. It also should be noted that stretching of the microporous membrane can be conducted at any point prior to, during, or subsequent to application of the pre-treatment composition (as described herein below), and/or prior to, during, or subsequent to application of the treatment composition. Stretching of the microporous membrane can occur once or multiple times during the treatment process.

The product passes to a first extraction zone where the processing plasticizer is substantially removed by extraction with an organic liquid, which is a good solvent for the processing plasticizer, a poor solvent for the organic polymer, and more volatile than the processing plasticizer. Usually, but not necessarily, both the processing plasticizer and the organic extraction liquid are substantially immiscible with water. The product then passes to a second extraction zone where the residual organic extraction liquid is substantially removed by steam and/or water. The product is then passed through a forced air dryer for substantial removal of residual water and remaining residual organic extraction liquid. From the dryer, the microporous material may be passed to a take-up roll, when it is in the form of a sheet.

The processing plasticizer has little solvating effect on the thermoplastic organic polymer at 60° C., only a moderate solvating effect at elevated temperatures on the order of 100° C., and a significant solvating effect at elevated temperatures on the order of 200° C. It is a liquid at room temperature and usually it is processing oil, such as paraffinic oil, naphthenic oil, or aromatic oil. Suitable processing oils include those meeting the requirements of ASTM D 2226-82, Types 103 and 104. Those oils which have a pour point of less than 22° C., or less than 10° C., according to ASTM D 97-66 (reapproved 1978) are used most often. Examples of suitable oils include SHELLFLEX 412 and SHELLFLEX 371 oil (Shell Oil Co. (Houston, TX)), which are solvent refined and hydrotreated oils derived from naphthenic crude. It is expected that other materials, including the phthalate ester plasticizers such as dibutyl phthalate, bis(2-ethylhexyl) phthalate, diisodecyl phthalate, dicyclohexyl phthalate, butyl benzyl phthalate, and ditridecyl phthalate will function satisfactorily as processing plasticizers.

There are many organic extraction liquids that can be used in the process of manufacturing the microporous membrane. Examples of suitable organic extraction liquids include, but are not limited to, 1,1,2-trichloroethylene; perchloroethylene; 1,2-dichloroethane; 1,1,1-trichloroethane; 1,1,2-trichloroethane; methylene chloride; chloroform; 1,1,2-trichloro-1,2,2-trifluoroethane; isopropyl alcohol; diethyl ether; acetone; hexane; heptane and toluene. One or more azeotropes of halogenated hydrocarbons selected from trans-1,2-dichloroethylene, 1,1,1,2,2,3,4,5,5,5-decafluoropentane, and/or 1,1,1,3,3-pentafluorobutane also can be employed. Such materials are available commercially as VERTREL MCA (a binary azeotrope of 1,1,1,2,2,3,4,5,5,5-dihydrodecafluoropentane and trans-1,2-dichloroethylene: 62%/38%) and VERTREL CCA (a ternary azeotrope of 1,1,1,2,2,3,4,5,5,5-dihydrodecafluorpentane, 1,1,1,3,3-pentafluorbutane, and trans-1,2-dichloroethylene: 33%/28%/39%); VERTREL SDG (80-83% trans-1,2-dichloroethylene, 17-20% hydrofluorocarbon mixture), all available from MicroCare Corporation (New Britain, CT).

In the above-described process for producing microporous membrane, extrusion and calendering are facilitated when the filler carries much of the processing plasticizer. The capacity of the filler particles to absorb and hold the processing plasticizer is a function of the surface area of the filler. Therefore, the filler typically has a high surface area as discussed above. Inasmuch as it is desirable to essentially retain the filler in the microporous material substrate, the filler should be substantially insoluble in the processing plasticizer and substantially insoluble in the organic extraction liquid when microporous material substrate is produced by the above process. The residual processing plasticizer content is usually less than 15 percent by weight of the resulting microporous material and this may be reduced even further to levels, such as less than 5 percent by weight, by additional extractions using the same or a different organic extraction liquid. The resulting microporous materials may be further processed depending on the desired application.

As previously mentioned, the method for treating a surface of a microporous membrane (as described above), comprises (1) contacting at least one surface of the membrane with a treatment composition comprising: (a) an acrylic polymer prepared from a mixture of vinyl monomers comprising: (i) a (meth)acrylic acid monomer and (ii) a silane-functional acrylic monomer; and optionally, (b) a base. Additionally, the acrylic polymer is in contact with the filler present in the matrix. The method further comprises: (2) subjecting the membrane of (1) to conditions sufficient to effect a condensation reaction between the inorganic filler and the acrylic polymer of the treatment composition.

The treatment composition for treating the surface of the microporous membrane includes (a) an acrylic polymer and optionally, (b) a base. The treatment composition may further include (c) at least one of poly(N-vinylpyrrolidone) or polyoxazoline.

The treatment composition may be a solution, with the components of the treatment composition (e.g., acrylic polymer (a), optional base (b), and optionally at least one of poly(N-vinylpyrrolidone) or polyoxazoline (c)) are dissolved in a solvent such as an alkyl alcohol or volatile ketone. Particularly suitable solvent include those with boiling points lower than 120° C., examples including methanol, ethanol, 1-propanol, 2-propanol, 1-butanol, 2-butanol, acetone, methylethyl ketone, and methylisobutyl ketone. Note that the base (b) is typically not necessary when the solution is not aqueous.

Alternatively, the treatment composition may be an aqueous treatment composition, with the components of the treatment composition (e.g., acrylic polymer (a), base (b), optionally at least one of poly(N-vinylpyrrolidone) or polyoxazoline (c) dispersed in an aqueous medium. When present, the base is typically used in a sufficient quantity to accomplish at least 100% neutralization of the (meth)acrylic acid monomer. As used herein, an “aqueous medium” refers to a liquid medium comprising at least 50 weight % water, based on the total weight of the liquid medium. Such aqueous liquid mediums can for example comprise at least 60 weight % water, or at least 70 weight % water, or at least 80 weight % water, or at least 90 weight % water, or at least 95 weight % water, or 100 weight % water, based on the total weight of the liquid medium. The solvents that, if present, make up less than 50 weight % of the liquid medium include organic solvents. Non-limiting examples of suitable organic solvents include polar organic solvents. By definition, a molecule may be “polar” either when there is an unequal sharing of electrons between the two atoms of a diatomic molecule or because of the assymmetrical arrangement of polar bonds in a more complex molecule, such that there is an overall dipole in the molecule. Examples of polar solvents include protic organic solvents such as glycols, alcohols, glycol ether alcohols, volatile ketones, glycol diethers, esters, and diesters. Other non-limiting examples of organic solvents include aromatic and aliphatic hydrocarbons. The treatment composition may have a pH>7.

The acrylic polymer (a) may be prepared from a mixture of vinyl monomers. The vinyl monomers usually include (i) a (meth)acrylic acid monomer and (ii) a silane-functional acrylic monomer. The vinyl monomers may include (iii) N-vinylpyrrolidone. The (meth)acrylic acid monomer (i) may be present in an amount of at least 2 percent by weight, or at least 5 percent by weight, and at most 20 percent by weight, or at most 10 percent by weight, such as 2-20 weight %, or 5-20 weight %, or 2-10 weight %, or 5-10 weight %, based on the total weight of the vinyl monomers. The silane-functional acrylic monomer (ii) may be present in an amount of at least 10 percent by weight, or at least 20 percent by weight, or at least 40 percent by weight, and at most 80 percent by weight, or at most 70 percent by weight, or at most 60 percent by weight; or at most 55 percent by weight; such as 10-80 weight %, or 10-70 weight %, or 10-60 weight %, or 10-55 weight %, or 20-80 weight %, or 20-70 weight %, or 20-60 weight %, or 20-55 weight %, or 40-80 weight %, or 40-70 weight %, or 40-60 weight %, or 40-55 weight %, based on the total weight of the vinyl monomers. The N-vinylpyrrolidone (iii), when present, may be present in an amount of at least 1 percent by weight, or at least 5 percent by weight, and at most 60 percent by weight; or at most 40 percent by weight; or at most 25 percent by weight; or at most 15 percent by weight; such as 1-60 weight %, or 1-40 weight %, or 1-25 weight %, or 1-15 weight %, or 5-60 weight %, or 5-40 weight %, or 5-25 weight %, or 5-15 weight %, based on the total weight of the vinyl monomers.

Other vinyl monomers may be present to prepare the acrylic polymer (a), and non-limiting examples may optionally include: methyl (meth)acrylate, ethyl (meth)acrylate, butyl (meth)acrylate, hydroxyethyl (meth)acrylate, hydroxybutyl (meth)acrylate, hydroxypropyl (meth)acrylate, styrene, acrylamide, alkyl substituted acrylamide, 2-ethylhexyl (meth)acrylate, isobornyl (meth)acrylate, cyclohexyl (meth)acrylate, lauryl (meth)acrylate, substituted styrenes, maleic anhydride, or combinations thereof.

As used herein, the term “acrylic” polymer refers to those polymers that are well known to those skilled in the art which result from the polymerization of one or more ethylenically unsaturated polymerizable materials. Acrylic polymers suitable for use can be made by any of a variety of methods, as will be understood by those skilled in the art. In certain examples, such acrylic polymers are made by addition polymerization of different unsaturated polymerizable materials, at least one of which is the (ii) silane-functional acrylic monomer. The result of such a polymerization is an acrylic polymer that comprises hydrolyzable silane functional groups. Examples of hydrolyzable silane groups include, without limitation, groups having the structure Si-Xn (wherein n is an integer having a value ranging from 1 to 3 and X is selected from chlorine, bromine, iodine, alkoxy esters, and/or acyloxy esters).

The (meth)acrylic acid monomer (i) may include acrylic acid, methacrylic acid, or a combination thereof.

Non-limiting examples of the silane-functional acrylic monomer (ii) include: ethylenically unsaturated alkoxy silanes and ethylenically unsaturated acyloxy silanes, more specific examples of which include acrylatoalkoxysilanes, such as gamma-acryloxypropyl trimethoxysilane and gamma-acryloxypropyl triethoxysilane, and methacrylatoalkoxysilanes, such as gamma-methacryloxypropyl trimethoxysilane, gamma-methacryloxypropyl triethoxysilane and gamma-methacryloxypropyl tris-(2-methoxyethoxy) silane; acyloxysilanes, including, for example, acrylato acetoxysilanes, methacrylato acetoxysilanes and ethylenically unsaturated acetoxysilanes, such as acrylatopropyl triacetoxysilane and methacrylatopropyl triacetoxysilane. In certain examples, it may be desirable to utilize monomers which, upon addition polymerization, will result in an acrylic polymer in which the Si atoms of the resulting hydrolyzable silyl groups are separated by at least two atoms from the backbone of the polymer. One non-limiting commercial example of a suitable (ii) silane-functional acrylic monomer includes SILQUEST A-174, available from Momentive Performance Materials (Waterford, NY).

The acrylic polymer (a) may have a weight average molecular weight (Mw, g/mol or Da) of at least 10,000 Da, or at least 12,000 Da, and up to 35,000, such as up to 30,000, or up to 25,000, or up to 20,000, or up to 16,000, or up to 15,000 Da. Thus, the Mw may range from 10,000-35,000, or 10,000-30,000, or 10,000-25,000, or 10,000-20,000, or 10,000-16,000, or 10,000-15,000, or 12,000-35,000, or 12,000-30,000, or 12,000-25,000, or 12,000-20,000, 12,000-16,000, or 12,000-15,000 Da. As used herein, Mw is measured by gel permeation chromatography using a polystyrene standard according to ASTM D6579-11 (gel permeation chromatography used to characterize the polymer samples, was performed using a Waters 2695 separation module with a Waters 2414 differential refractometer (RI detector); tetrahydrofuran (THF) was used as the eluent at a flow rate of 1 ml/min, and two PLgel Mixed-C (300×7.5 mm) columns were used for separation; Mw of polymeric samples can be measured by gel permeation chromatography relative to linear polystyrene standards of 800 to 900,000 Da).

The acrylic polymer (a) may be in contact with the filler present in the matrix once the treatment composition is applied to the microporous membrane, such that the membrane may be subjected to conditions sufficient to effect a condensation reaction between the filler and the acrylic polymer (a).

In some non-limiting examples, the acrylic polymer (a) may make up 90-100 weight % of the solids in the treatment composition.

The base (b) may include any compound capable of neutralizing the (meth)acrylic acid monomer (a). The base (b) may be included in an amount to at least partially neutralize the (meth)acrylic acid monomer (i). For example, the base (b) may be included in an amount sufficient to neutralize at least 50%, or at least 75%, or at least 100% of the (i) (meth)acrylic acid monomer. For example, the base (b) may be included in an amount sufficient to neutralize up to 250%, or up to 300%, or up to 400% the (meth)acrylic acid monomer (i). The base (b) may be included in a sufficient quantity in the treatment composition to accomplish 100%-300%, such as 110-250%, or such as 150%-200% neutralization of the (meth)acrylic acid monomer (i).

Non-limiting examples of the base (b) include an amine (e.g., dimethylethanol amine, dibutyl amine, diisopropyl amine, amine-functional alkoxysilanes), sodium hydroxide, ammonium hydroxide, and the like. The amine may include a tertiary amine. aAmmonium hydroxide, dimethylethanol amine, dibutyl amine, and diisopropyl amine are particularly suitable.

The optional poly(N-vinylpyrrolidone) or polyoxazoline (c) may include polyalkyloxazolines such as poly(2-ethyl-2-oxazoline), poly(2-methyl-2-oxazoline), and poly(2-methyl/ethyl-2-oxazoline); and/or a poly(N-vinylpyrrolidone).

In some non-limiting examples, the poly(N-vinylpyrrolidone) or polyoxazoline (c) may make up 1-20 weight % of the solids in the treatment composition.

Prior to contacting the treatment composition with at least one surface of the microporous membrane, the microporous membrane may be pre-treated with a pre-treatment composition. The surface of the microporous membrane may be pre-treated by contacting it with a hydrophilic polymer. By “hydrophilic” is meant the polymer has polar properties and has a tendency to interact with, be miscible with, or be dissolved by water and other polar substances. The hydrophilic polymer (c) may include any of the hydrophilic polymers from US Patent Application Publication No. 2014/0069862, paragraph [0090], such as one or more of a polyoxazoline, including polyalkyloxazolines such as poly(2-ethyl-2-oxazoline), poly(2-methyl-2-oxazoline), and poly(2-methyl/ethyl-2-oxazoline); triblock copolymers based on poly(ethylene glycol)-poly(propylene glycol)-poly(ethylene glycol); polyethyleneimine; polyamide; oxidized polyethylene or its derivatives; polyethyleneoxide; polyethyleneglycol; poly(N-vinylpyrrolidone); polyacrylic acid; polymethacrylic acid; polyethylene glycol derivatives; polypropylene oxide or its derivatives; a copolymer of poly(ethylene glycol) and polyethyleneoxide; polyvinyl alcohol; ethylene vinyl acetate; cellulose or its derivatives; polyimide; hydrogels such as collagen, polypeptides, guar and pectin; polypeptides; poly(meth)acrylates such as poly(2-hydroxyethylmethacrylate); poly(meth)acrylamide; polysaccharides such as chitosan; zwitterionic polymers such as poly(phosphorylcholine) derivatives, polysulfobetaines, and polycarbobetaines; polyampholytes, or polyethylenimine. The pre-treated microporous membrane may be dried prior to contacting it with the treatment composition, or the treatment composition may be contacted over the surface wet from the pre-treatment. In some non-limiting examples, the surface of the microporous membrane may be contacted with the hydrophilic polymer after it is contacted with the treatment composition, such that the hydrophilic polymer is used as a post-treatment composition. This may be in addition to using the hydrophilic polymer as a pre-treatment composition or instead of using the hydrophilic polymer as a pre-treatment.

The pre-treatment composition and/or the treatment composition can be (1) contacted with at least one surface of the microporous membrane by any application means known in the art. For example, the treatment composition can be applied to at least one surface of the microporous membrane by immersion, spray, dip, and/or flow or certain application techniques. The treatment composition may be applied after plasticizer extraction and either prior to, during, or after any of the stretching steps previously described. Alternatively, stretching can be delayed until application of the treatment composition.

The treatment composition may be applied over a membrane that is dry or pre-wet.

Upon application of the treatment composition to at least one surface of the microporous membrane in (1), a silane-treated membrane is formed. The silane-treated membrane of (1) is then (2) subjected to conditions sufficient to effect a condensation reaction between the inorganic filler (e.g., functional groups present on the surface thereof) and the acrylic polymer (a) (e.g., via the silane groups present from the silane-functional acrylic monomer (ii) residue). Such reaction conditions will be discussed in more detail herein below.

The (2) conditions sufficient to effect the condensation reaction may include drying as described hereinafter. The (2) conditions sufficient to effect the condensation reaction may include adjusting the pH to a range from 4 to 7, such as by rinsing the membrane with water (e. g., deionized or distilled) or a dilute aqueous acid.

Further, the treatment composition can be applied in multiple steps. That is, the microporous membrane can be contacted in (1) with one or more applications of the treatment composition(s). Moreover, the treatment compositions applied in such multi-step applications can be the same or different compositions, provided each composition comprises at least one acrylic polymer (a). It also should be noted that any of the previously described treatment compositions suitable for application to the microporous membrane of (1) in accordance with the disclosed method can further comprise at least one nonionic surfactant and/or anionic surfactant and/or rheology modifier as described immediately below.

Non-limiting examples of suitable anionic surfactants for use in the treatment composition used in the disclosed method can include, but are not limited to, sodium stearate, ammonium stearate, ammonium cocoate, sodium laurate, sodium cocyl sarcosinate, sodium lauroyl sarconsinate, sodium soap of tallow, sodium soap of coconut, sodium myristoyl sarcosinate, sodium dioctylsulfosuccinate, or some combination thereof.

The rheology modifier may be pseudoplastic or thixotropic in nature. Non-limiting examples of suitable rheology modifiers for use in the treatment composition used in the disclosed method can include, but are not limited to, cationic quaternary amine compounds coupled with propylene glycol (such as DISPERSOGEN SPS from Clariant (Muttenz, Switzerland)), aqueous dispersions of acrylic copolymers (such as RHEOTECH 4800 from Arkema Group (Colombes, France)), anionic, aqueous solutions of sodium polyacrylate (such as ALCOGUM 296-W from AkzoNobel (Amsterdam, Netherlands)), or some combination thereof.

Non-limiting examples of suitable nonionic surfactants for use in the treatment composition used in the disclosed method can include, but are not limited to, polyalkylene oxide alkyl ethers, wherein the alkyl group can be straight chain or branched having a chain length of from C6 to C22; polyalkylene oxide alkyl esters, wherein the alkyl group can be straight chain or branched having a chain length of from C6 to C22; organic amines with straight or branched carbon chains from C6 to C22 having the general formula R*NR′R″, wherein R* can be from C8 to C22 alkyl and R′ and R″ can each independently be H or C₁ to C₄ alkyl, such that the molecule can be substantially soluble or substantially emulsifiable in water, for example octadecylamine; tertiary amines with carbon chains from C6 to C22; polyethyleneimines; polyacrylamides; glycols and alcohols with straight chain or branched alkyl from C6 to C22 that can form ester linkage (—SiOC—), polyvinyl alcohol; and mixtures thereof.

The nonionic surfactant also can be chosen from polyalkylene oxide ethers such as polypropylene oxide ethers or polyethylene oxide ethers such as but not limited to hexaethylene glycol monododecylether, hexaethylene glycol monohexadecylether, hexaethylene glycol monotetradecylether, hexaethylene glycol monooctadecylether, heptaethylene glycol monododecylether, heptaethylene glycol monohexadecylether, heptaethylene glycol monotetradecylether, heptaethylene glycol monooctadecylether, nonaethylene glycol monododecylether, octaethylene glycol monododecylether; polyalkylene oxide esters, for example polypropylene oxide esters or polyethylene oxide esters such as but not limited to hexaethylene glycol monododecylester, hexaethylene glycol monohexadecylester, hexaethylene glycol monotetradecylester, hexaethylene glycol monooctadecylester, heptaethylene glycol monododecylester, heptaethylene glycol monohexadecylester, heptaethylene glycol monotetradecylester, heptaethylene glycol monooctadecylester, nonaethylene glycol monododecylester, octaethylene glycol monododecylester; polysorbate esters such as polyoxyethylene sorbitan mono fatty acid esters including but not limited to polyoxyethylene sorbitan mono palmitate, polyoxyethylene sorbitan mono oleate, polyoxyethylene sorbitan mono stearate, polyoxyethylene sorbitan difatty acid esters such as polyoxyethylene sorbitan dipalmitate, polyoxyethylene sorbitan dioleate, polyoxyethylene sorbitan distearate, polyoxyethylene sorbitan monopalmitate monooleate, polyoxyethylene sorbitan tri fatty acid esters such as but not limited to polyoxyethylene sorbitan tristearate; or mixtures thereof.

In a particular example, the treatment composition can comprise a nonionic surfactant selected from block copolymers based on poly(ethylene glycol), for example, block copolymers of poly(propylene glycol) and poly(ethylene glycol), (such as the triblock copolymer PLURONIC 17R2, which is commercially available from BASF Corporation (Ludwigshafen, Germany)); cetylstearyl alcohol; polyethylene glycol and derivatives thereof, for example, polyoxyethylene octyl phenyl ether; polyalkyl glycols; cetyl alcohol; cocamide mono- or di-ethanolamine; decyl glucoside; octylphenoxypolyethoxyethanol; isocetyl alcohol; lauryl glucoside; monolaurin; fatty alcohol polyglycol ethers; polyglycol ethers; polyethylene glycol derivatives of mono or diglycerides; mono and poly glycerol derivatives, for example, polyglycerol polyricinoleate; sorbitan esters; polysorbates and oxidized polyethylene. Mixtures of any of the aforementioned nonionic surfactants can be used.

As discussed above, the method for treating a surface of a filled microporous membrane further comprises (2) subjecting the membrane of (1) to conditions sufficient to effect a condensation reaction between the inorganic filler and the silane-functional polyamine compound.

In a “wet method”, the treatment composition can be applied to one or more surfaces of the microporous membrane and rinsed with water to effect the condensation reaction between the inorganic filler and the (a) acrylic polymer. The wet method can be used effectively to treat a microporous membrane which is in the form of a sheet or when the microporous membrane is a component of an existing or pre-fabricated separation device, such as the filter membrane component of hollow fibers, a tubular device, a spiral wound or pleated filter device, or a separation membrane as a component of a battery (e.g., a battery separator). The sheet may be pre-wetted or dry prior to the treatment with the treatment composition.

In a “dry method” of effecting the condensation reaction in step (2) of the disclosed method, the condensation reaction between the inorganic filler and the (a) acrylic polymer is effected by drying the membrane. The dry method may be used when the base (b) has a vapor pressure of ≥1 Pa. The dry method is particularly useful for treatment of microporous membranes in the form of a sheet. The dry method can be initiated on a microporous membrane prior to any stretching, or after machine direction stretching and prior to a cross direction stretching, or the dry method can be initiated on a microporous membrane that has already undergone biaxial stretching. Also, when the dry method is employed, the microporous membrane may be stretched during the drying/heating step in addition to or instead of stretching prior to treatment with the treatment composition. During application of the treatment composition in the dry method, it should be noted that the microporous membrane to which the respective treatment composition is applied should be held dimensionally stable during said application and drying steps. Further, during the dry method drying/heating steps, the membrane typically is held under tension in order to prevent/minimize shrinkage, regardless of whether the stretching is occurring simultaneously.

The drying temperature to effect the condensation reaction may occur in a temperature range of at least 20° C. and up to 145° C., or up to 120° C., or up to 100° C., or up to 95° C. Exemplary temperature ranges include 20° C.-145° C., 20° C.-120° C., 20° C.-100° C., and 20° C.-95° C.

In certain examples of the method, at this point the membrane resulting from step (2) may be formed into a filtration device, such as hollow fibers, a tubular device, a spiral wound filtration device or a pleated filtration device, which may be in the form of a filtration cartridge, depending on the intended application. Alternatively, the membrane can be formed into a filtration device following any subsequent treatment step.

The method further comprises (3) contacting at least one surface of the silane-treated membrane with a dispersion comprising an amine-functional polysaccharide dispersed in an aqueous medium containing an organic acid, to form a polysaccharide-treated membrane. Typically, the silane-treated membrane is immersed in the dispersion, and/or the dispersion may be passed (once) or circulated (multiple times) through the membrane, for about 15 to 30 minutes at ambient temperature. By “ambient temperature” is meant the surrounding temperature without the application of heat or other energy. Usually ambient temperature ranges from 60 to 90° F. (15.6 to 32.2° C.), such as a typical room temperature, 72° F. (22.2° C.).

Examples of amine-functional polysaccharides include polygalactosamine, polymannosamines, polyfructosamines, polyglucosamines and the like. Common polyglucosamines include poly-D-glucosamine and chitosan, a partially deacetylated poly-N-acetyl-D-glucosamine derived from the shells of crustaceans (note, greater than 60% deacetylated is most suitable). To the extent to which the polysaccharide is soluble in acidic solution, the amine-functional polysaccharide may be present in the dispersion in an amount of at least 0.25 percent by weight, or at least 0.50 percent by weight, or at least 0.75 percent by weight, and at most 15 percent by weight, or at most 10 percent by weight, or at most 5 percent by weight, based on the total weight of the dispersion.

Examples of organic acids that may be used in the aqueous medium include formic acid, acetic acid, lactic acid, benzoic acid, propanoic acid, and the like. Mixtures of acids may also be used. The pH of the dispersion is adjusted with the organic acid to below 6.5, such as a pH of from 1-6.

At least one surface of the polysaccharide-treated membrane formed in (3) is then (4) contacted with an aqueous acid, which at least partially neutralizes the amine functional groups on the polysaccharide (thus forming ammonium salt groups), followed by (5) contacting with an amine-functional alkoxysilane to form a polysaccharide hydrogel layer on the membrane. In each of these steps, again, the membrane may be immersed and/or the relevant treatment solution may be passed or circulated through the membrane at ambient temperature.

Aqueous acids for use in step (4) may be organic or inorganic; usually the aqueous acid comprises an inorganic acid such as boric acid, sulfuric acid, or phosphoric acid. Mixtures of acids may also be used. The acid may have 2 or more protons capable of forming ammonium salts on the amine groups present on the polysaccharide and forming loosely crosslinked network (not to be bound by theory).

The amine-functional alkoxysilane may include: aminopropyltriethoxysilane, aminopropyltrimethoxysilane, aminobutyltriethoxysilane, aminobutyltrimethoxysilane, aminophenyltrimethoxysilane, 3-aminopropyltris (methoxyethoxyethoxy) silane, 11-aminoundecyltriethoxysilane, 2-(4-pyridylethyl)triethoxysilane, aminopropylsilanetriol, 3-(m-aminophenoxy) propyltrimethoxy silane, 3-aminopropylmethyldiethoxysilane, 3-amino propylmethyldiethoxysilane silane, 3-aminopropyldimethylethoxysilane, or some combination thereof. The amine-functional alkoxysilane may include a polyaminosilane. Non-limiting examples of polyaminosilanes include: N-(2-aminoethyl)-3-aminopropyltriethoxysilane, N-(2-aminoethyl)-3-aminopropyl-silanetriol, N-(2-aminoethyl)-3-aminopropylmethyldimethoxysilane, N-(2-aminoethyl)-3-aminoisobutyl methyldimethoxysilane, bis(2-hydroxyethyl)-3-aminopropyltriethoxysilane, diethylaminomethyltriethoxysilane, N,N-diethyl-3-aminopropyl)trimethoxysilane, 3-(N-styrylmethyl-2-aminoethylamino) propyltrimethoxysilane hydrochloride, N-trimethoxysilylpropyl-N,N,N-trimethylammonium chloride, N-(trimethoxysilylethyl)benzyl-N,N,N-trimethylammonium chloride, trimethoxysilylpropyl modified (polyethyleneimine), or some combination thereof.

Alternatively, the amine-functional alkoxysilane may comprise a reaction product of (i) a polyamine having at least one primary amino group and/or at least one secondary amino group with (ii) an epoxy-functional silane. In this example, the polyamine (i) used to form the amine-functional alkoxysilane may comprise polyethyleneimine, N-(3-aminopropyl)-1,4-butanediamine, N,N′-bis(3-aminopropyl)-1,4-butanediamine, N-(3-aminopropyl)-N′-[3-[(3-aminopropyl)amino]propyl]propane-1,3-diamine, 1,13-diamino-5,9-diazatridecane, triethylene tetraamine, diethylene triamine, and/or 1-(2-aminoethyl) piperazine. Suitable epoxy-functional silanes for use as the epoxy-functional silane (ii) can be any of those selected from the group consisting of di-epoxy functional silanes, epoxy cyclohexylsilanes, epoxy cyclohexylalkyl silanes, glycidoxyalkyl silanes, and mixtures thereof. Particular examples of the epoxy-functional silane (ii) used to form the amine-functional alkoxysilane include (3-glycidoxypropyl) trialkoxysilane, (3-glycidoxypropyl) bis(trimethylsiloxy)methylsilane, (3-glycidoxypropyl) dimethylethoxysilane, and/or (3-glycidoxypropyl)methyldiethoxysilane.

The reaction of a polyamine with an epoxy-functional silane containing at least one condensable or hydrolysable group may be performed “neat” or in the presence of a solvent. The reaction of a polyamine with an epoxy-functional silane may be performed in a polar solvent. Some non-limiting examples of suitable polar solvents that may be used include those disclosed above; in particular, water or alcohol, such as a C₁ to C₆ alcohol, or mixtures of water and one or more of the C₁ to C₆ alcohols. Such suitable C₁ to C₆ alcohols can be any of those selected from the group consisting of methanol, ethanol, 1-propanol, isopropanol, 1-butanol, 2-butanol, 1-hexanol, and mixtures thereof. An acid, such as acetic acid, hydrochloric acid, sulfuric acid, nitric acid, carbonic acid, lactic acid, citric acid, phosphoric acid, and/or oxalic acid, may be present to aid dissolution of the polyamine. The acid may be present in the reaction mixture in an amount from greater than 0 percent by weight, or at least 1 percent, and at most 10 percent, or at most 5 percent by weight, or at most 2 percent by weight, based on the total weight of the reaction mixture. For example, the acid may be present in the reaction mixture in an amount from greater than 0 to at most 10 percent, or greater than 0 to at most 5 percent, or greater than 0 to at most 2 percent, or from 1 to 10 percent, or from 1 to 5 percent, or from 1 to 2 percent. This solution may be used as the treatment composition comprising a silane-functional polyamine, or a portion of the solvent may be removed, for example, by stripping or distillation techniques as are well known in the art. Also, the reaction of a polyamine with an epoxy-functional silane may be achieved via heating. The exact reaction temperature depends on a variety of factors, including the specific reactants selected and the type of solvent used. Temperatures, however, generally range from ambient to 90° C. and reaction time may be several hours, such as up to 5 hours, for example from 0.5 hour to 2 hours.

Typically, the molar ratio of the sum of primary and secondary amino groups present in the polyamine (i) to epoxy groups present in the epoxy-functional silane (ii) ranges from 1:1 to 100:1, such as from 3:1 to 50:1, or 4:1 to 40:1, or 6:1 to 25:1.

The amine-functional alkoxysilane often comprises 3-aminopropyltriethoxysilane, 3-aminopropyltrimethoxysilane, 3-trimethoxysilylpropyl)diethylenetriamine, trimethoxysilylpropyl modified (polyethyleneimine), and/or dimethoxysilylmethylpropyl modified (polyethyleneimine).

The amine-functional alkoxysilane may be combined with a surfactant, particularly a nonionic surfactant. Suitable examples include those described previously.

It is believed that steps (4) and (5) allow for the formation of a polysaccharide hydrogel layer on the membrane. As used herein, a “hydrogel” is a water-insoluble, 3-dimensional network of physically or chemically bonded polymer chains that can entrap water in intermolecular space. Typically, the treated microporous membrane is kept wet after treatment and during storage, such as by filling with an aqueous solution, to prevent degradation of the hydrogel on the membrane surface.

The present disclosure is further drawn to a method for treating a filtration device, the filtration device comprising a microporous membrane, the microporous membrane comprising an organic thermoplastic matrix; finely divided particulate, substantially water-insoluble inorganic filler distributed throughout the matrix; a network of interconnecting pores communicating throughout the microporous membrane, and an acid-functional acrylic layer on at least one surface of the microporous membrane, wherein the acid-functional acrylic layer is bonded to the filler via siloxane functional groups. An example of a suitable filtration device may be formed from a microporous membrane treated in accordance with steps (1) and (2) in the method described above. A typical filtration device is in the form of hollow fibers, a tubular device, a spiral wound filtration device or a pleated filtration device, usually housed within a cartridge.

In the method for treating a filtration device of the present disclosure, (1) at least one surface of the acid-functional acrylic layer on the microporous membrane is contacted with a dispersion comprising an amine-functional polysaccharide dispersed in an aqueous medium containing an organic acid, to form a polysaccharide-treated membrane. Such a dispersion may comprise any of those disclosed above.

At least one surface of the polysaccharide-treated membrane formed in (1) is then (2) contacted with an aqueous acid, followed by (3) contacted with an amine-functional alkoxysilane to form a polysaccharide hydrogel layer on the membrane. Aqueous acids for use in step (2) may be organic or inorganic; usually the aqueous acid comprises an inorganic acid as above. Likewise, the amine-functional alkoxysilane used in step (3) often comprises 3-aminopropyltriethoxysilane, 3-aminopropyltrimethoxysilane, 3-trimethoxysilylpropyl)diethylenetriamine, trimethoxysilylpropyl modified (polyethyleneimine), and/or dimethoxysilylmethylpropyl modified (polyethyleneimine).

Alternatively, the amine-functional alkoxysilane may comprise a reaction product of (i) a polyamine having at least one primary amino group and/or at least one secondary amino group with (ii) an epoxy-functional silane. Examples of polyamines (i) and epoxy-functional silanes (ii) used to form the amine-functional alkoxysilane include any of those disclosed above.

Steps (1) to (3) of the method for treating a filtration device may each be performed in a manner similar to those described above for the analogous process steps in the method for treating a surface of a microporous membrane. Again, the membrane on the treated filtration device is usually kept wet after treatment and during storage to prevent degradation of the hydrogel on the membrane surface.

The present disclosure is further drawn to a treated microporous membrane comprising (1) a microporous membrane comprising an organic thermoplastic matrix; finely divided particulate, substantially water-insoluble inorganic filler distributed throughout the matrix; and a network of interconnecting pores communicating throughout the microporous membrane; (2) an acrylic layer on at least one surface of the microporous membrane, wherein the acrylic layer is bonded to the filler via siloxane functional groups; and (3) a hydrogel layer on at least one surface of the acrylic layer, wherein the hydrogel layer is formed from an amine-functional polysaccharide and an amine-functional alkoxysilane. The treated microporous membrane may be in the form of a sheet, and/or a component of a filtration device, such as hollow fibers, a tubular device, a spiral wound filtration device or a pleated filtration device, and/or within a cartridge, depending on the intended application. The treated microporous membrane may, for example, be prepared using the methods described above.

The microporous membrane (1) typically comprises any of those described above. For example, the organic thermoplastic matrix may comprise polyacrylonitrile, cellulose nitrate, polycarbonate, cellulose acetate, polytetrafluoroethylene (PTFE), polyamide, polyolefin, polyetherketone, polyvinylidene fluoride (PVDF), polysulfone, and/or polyethersulfone, while the filler may comprise silica, alumina, calcium oxide, zinc oxide, magnesium oxide, titanium oxide, and/or zirconium oxide. The microporous membrane (1) often comprises a polyolefinic matrix and a silica filler.

The acrylic layer (2) may be formed from a mixture of vinyl monomers comprising: (i) a (meth)acrylic acid monomer and (ii) a silane-functional acrylic monomer. The monomers (i) and (ii) may be any of those disclosed above. In particular examples, the mixture of vinyl monomers used to form the acrylic layer (2) further comprises (iii) N-vinylpyrrolidone.

As noted above, the treated microporous membrane further comprises a hydrogel layer (3) on at least one surface of the acrylic layer. The hydrogel layer is formed from an amine-functional polysaccharide and an amine-functional alkoxysilane such as described above (the amine groups may be previously converted to ammonium salt groups). The hydrogel layer may be formed using any of the amine-functional polysaccharides and amine-functional alkoxysilanes disclosed above.

It has been found that, when used in oil-water separation applications, the treated membranes of the present disclosure and the treated membranes and filtration devices prepared by the disclosed methods exhibit a longer practical lifetime as evidenced by decreased fouling, improved flux rates over extended periods of time, and robustness against cleaning procedures as compared to an equivalent, untreated membrane. Such membranes also can demonstrate higher oil retention, especially under high operating pressures; i.e., pressures above 15 psi, such as above 30 psi, or above 40 psi, and pressure up to 100 psi.

The following working Examples are intended to further describe and demonstrate the membranes and treatment methods described herein. It is understood that the disclosure of this specification is not necessarily limited to the examples described in this section. Components that are mentioned elsewhere in the specification as suitable alternative materials for use, but which are not demonstrated in the working Examples below, are expected to provide results comparable to their demonstrated counterparts. Unless otherwise indicated, all parts are by weight.

### EXAMPLES

### Part 1: Method to Produce and Treat the Membrane

An extruded sheet was prepared in accordance with Example M-2 of U.S. Pat. No. 10,888,821A1 and used as the substrate for all the following examples.

### Part 1. Preparation of Treatment Compositions

Part 1a. Preparation of Acrylic Polymer Dispersion:

An acrylic polymer was prepared from the following components listed in Table 1.

Charge A was placed into a 4-neck round bottom flask with condenser, nitrogen adaptor, mechanical stirrer, and addition funnel, and the reaction was heated to 80° C. under nitrogen blanket with agitation. Charges B and C were then added simultaneously over three hours at reflux then held at reflux for an additional two hours. Charge D was then added over thirty minutes at 80° C. The reaction mixture was held for an additional two hours at 80° C. The clear solution was then cooled to 50° C., and poured into Charge E with agitation over fifteen minutes. The solution was stirred for 30 minutes and then filtered through a 100 micron mesh filter bag. The percent solids were checked by heating a sample at 110° C. for 1 hour in an oven (10.36% solids)

TABLE 1
Acrylic polymer composition

| | Parts |
|---|---|
| | by |
| Component | weight |
| A | |
| Ethanol (95%, 5% methanol) | 78.11 |
| B | |
| Ethanol (95%, 5% methanol) | 20.61 |
| Methyl Methacrylate | 39.92 |
| Butyl Acrylate | 0.11 |
| Hydroxyethyl Methacrylate | 0.11 |
| Acrylic acid | 7.49 |
| Methacryloxypropyltrimethyloxy | 42.40 |
| Silane | |
| N-Vinyl pyrrolidone | 9.98 |
| C | |
| Ethanol (95%, 5% methanol) | 52.92 |
| 2,2′-azobis(2- | 4.23 |
| methylbutyronitrile) | |
| D | |
| Ethanol (95%, 5% methanol) | 6.25 |
| 2,2′-azobis(2- | 0.99 |
| methylbutyronitrile) | |
| E | |
| De-ionized water | 761.30 |
| Ethanol (90%, 10% water) | 38.06 |
| Sodium dioctyl sulfosuccinate | 2.69 |
| Dimethylethanolamine | 18.35 |

Part 1b. Acrylic Treatment Solution

A polyethylene beaker fitted with an air driven paddle stirrer was charged with water and 2-butoxyethanol according the amounts in Table 2. After stirring for 5 minutes, the acrylic polymer dispersion of Part 1a was added slowly to yield a solution with a pH between 9 and 10.

TABLE 2
Acrylic treatment solution

| Ingredients | |
|---|---|
| (parts by weight) | Example 4 |
| Water | 34.0 |
| 2-Butoxyethanol | 6.0 |
| Acrylic polymer | 60.0 |
| solution of Part 1a | |

Part 1c. Preparation of Polysaccharide Treatment Solution:

A 1% by weight solution of chitosan (from shrimp shells, ≥75% deacetylated) in 2% acetic acid was prepared by stirring until the solids were completely dissolved.

Part 1d. Preparation of Amine-Functional Alkoxysilane Treatment Solution

A polyethylene beaker fitted with air driven paddle stirrer was charged with cool water and agitated to generate approximately a 1″ vortex. The specified amount of poly(2-ethyl-2-oxazoline) was added and stirred for 4 hours. The 2-butoxyethanol and surfactant were added and the solution was stirred for an additional 30 minutes. The 3-aminopropyltriethoxysilane was then added and the solution stirred for 15 minutes. The trimethoxysilylpropyl-polyethyleneimine solution was added to the main mix container and stirred for a minimum of 5 minutes prior to use.

TABLE 3
The formulation of second treatment solution

| Ingredients (parts by weight) | (%) |
|---|---|
| Water | 77.3 |
| Poly(2-ethyl-2-oxazoline)¹ | 1.7 |
| 2-butoxyethanol | 5.1 |
| PLURONIC ® 17R2² | 0.9 |
| 3-aminopropyltriethoxysilane³ | 7.5 |
| trimethoxysilylpropyl- | 7.5 |
| polyethylenimine⁴ | |

¹Average Molecular weight of 50,000, supplied by SigmaAldrich.
²A block copolymer surfactant with reported weight average M_{w} of 2150, available from BASF Corporation.
³A 50% solution in isopropyl alcohol, sold under the product code SSP-060 by Gelest, Inc.
⁴A branched polyethyleneimine with reported average Mn of 10,000 and Mw of 25,000 purchased from Sigma-Aldrich under the product number 408727.

### Part 2. Treatment of Membranes

### Example 1

### Step 1.

A sheet of the microporous membrane was cut to approximately 10.5″×10.5″ and clamped to the outer perimeter of a 12″×12″ metal frame with 1″ binder clips. The solution of Part 1b was applied sufficient to give a targeted coating weight of 281 g/m². The framed sample was placed in an oven set at 95° C. for 10 minutes. The assembly was then allowed to cool to room temperature.

### Step 2.

The chitosan solution of Part 1c was applied until the liquid no longer absorbed into the membrane as evidenced by standing liquid on the surface, which was then wiped off and followed by a hold time of 15 minutes in sealed plastic bag. The treated membrane was kept moist in the bag until the next step.

### Step 3.

The membrane of step 2 was placed in 2.5% H₂SO₄ for 30 min, followed by rising with water. Then the membrane was placed into a sealed plastic bag and kept moist until the next step.

### Step 4.

The membrane of step 3 was fully submerge into the amine-functional silane solution prepared in Part 1d. The membrane remained submerged for 15 minutes, followed by rising with water. Then the membrane was placed in a sealed plastic bag and kept moist in the bag for testing.

### Comparative Example CE-2

A sheet of the microporous membrane was prepared and subjected to Step 1 of Example 1 to provide a silane (acrylic) treated membrane.

### Comparative Example CE-3

A sheet of the microporous membrane was left untreated and used as Comparative Example CE-3.

### Part 3: Performance Testing of Membranes

Water flux: Water flux was tested with a Sterlitech filter holder with a membrane area of 90 cm². The Sterlitech unit fitted with the membrane was charged with 1 liter of water and sealed. The air pressure was set to 50 psi and the time required for the 1 liter quantity of water to pass through the membrane was recorded. The corresponding water flux was calculated.
Oil resistance: The water-wetted membrane of interest was removed from the water flux test equipment above and immediately evaluated for oil resistance. Three drops of oil were placed on the membrane surface using a disposable dropper. All three drops were allowed to remain undisturbed for approximately one minute then wiped off using a paper wipe. If the oil drop penetrated and stained the membrane, the result was given a rating of 1. If the oil drop remained mostly on the surface but clearly stained the membrane, the result was given a rating of 2. If the oil drop remained at the surface, did not penetrate the membrane and/or only slightly stained the surface, the result was given a rating of 3.
Oil absorption test: A 2 cm by 2 cm coupon of membrane was completed submerged into 100% crude oil for 24 hours. The sample was then removed from the oil bath and all excess oil wiped from the surface. The resultant sample was placed in a beaker filled with 100 ml of hexane, allowed to soak for 5 minutes and then removed. The corresponding oil concentration in the hexane soak was determined with a TD-3100 from Turner Design hydrocarbon Instruments.
Water/oil extrusion pressure test: A 200 ml quantity of a 50/50 volume blend of water and Texas crude oil (purchased from Texas Crude) was used for the test along with a Sterlitech filter holder with a membrane area of 90 cm². Once the Sterlitech unit was fully fitted and charged the test was initiated at a pressure of 5 psi and then the pressure was increased at 0.5 psi increments every 5 minutes. The pressures at which water and then oil passed through the membrane were recorded. The difference between these two pressures is recorded in Table 5 as ΔP oil−water. A larger ΔP corresponds to a larger window of operable pressures with less chance of oil passing through as a contaminant to the permeate.

TABLE 7
Membrane performance for different membranes

| | | | | | Δ |
|---|---|---|---|---|---|
| | | Water | | Oil | P |
| | | Flux | Oil | Absorp- | Oil- |
| Ex- | | (ml/min/ | Resist- | tion | Water |
| amples | Process | cm²) | ance | (mg/cm²) | (psi) |
| Ex-2 | Fully | 6 | 3 | 3.4 | 13.5 |
| | treated | | | | |
| | membrane | | | | |
| CE-2 | Acrylic | 18 | 3 | 8.3 | 5 |
| | silane | | | | |
| | treatment | | | | |
| | only | | | | |
| CE-3 | No | 21.2 | 1 | 14.2 | 5 |
| | treatment | | | | |

Higher delta P is better for higher pressure applications.

Whereas particular examples of this invention have been described above for purposes of illustration, it will be evident to those skilled in the art that numerous variations of the details of the present invention may be made without departing from the invention as defined in the appended claims.

1. A method for treating a surface of a microporous membrane, the microporous membrane comprising an organic thermoplastic matrix; finely divided particulate, substantially water-insoluble inorganic filler distributed throughout the matrix; and a network of interconnecting pores communicating throughout the microporous membrane, the method comprising in sequence:
(1) contacting at least one surface of the microporous membrane with a treatment composition to form a silane-treated membrane, the treatment composition comprising:
(a) an acrylic polymer prepared from a mixture of vinyl monomers comprising: (i) a (meth)acrylic acid monomer and (ii) a silane-functional acrylic monomer; and
(b) optionally, a base,
wherein the acrylic polymer is in contact with the filler present in the matrix;
(2) subjecting the silane-treated membrane formed in (1) to conditions sufficient to effect a condensation reaction between the filler and the acrylic polymer;
(3) contacting at least one surface of the silane-treated membrane with a dispersion comprising an amine-functional polysaccharide dispersed in an aqueous medium containing an organic acid, to form a polysaccharide-treated membrane;
(4) contacting at least one surface of the polysaccharide-treated membrane formed in (3) with an aqueous acid; and
(5) contacting the polysaccharide-treated membrane with an amine-functional alkoxysilane to form a polysaccharide hydrogel layer on the membrane.

2. The method of claim 1, wherein the organic thermoplastic matrix comprises polyacrylonitrile, cellulose nitrate, polycarbonate, cellulose acetate, polytetrafluoroethylene (PTFE), polyamide, polyolefin, polyetherketone, polyvinylidene fluoride (PVDF), polysulfone, and/or polyethersulfone; and wherein the filler comprises silica, alumina, calcium oxide, zinc oxide, magnesium oxide, titanium oxide, and/or zirconium oxide.

3. The method of claim 1, further comprising the step of assembling the membrane of step (2) into hollow fibers, a tubular device, a spiral wound filtration device or a pleated filtration device prior to step (3).

4. The method of claim 1, wherein the mixture of vinyl monomers further comprises (iii) N-vinylpyrrolidone.

5. The method of claim 1, wherein the treatment composition of step (1) further comprises (c) at least one of poly(N-vinylpyrrolidone) and/or polyoxazoline.

6-10. (canceled)

11. The method of claim 1, wherein subjecting the silane-treated membrane formed in (1) to conditions sufficient to effect a condensation reaction between the filler and the acrylic polymer comprises either (a) drying the membrane in step (2); or (b) adjusting the pH to a range from 4 to 7 in step (2).

12-13. (canceled)

14. The method of claim 1, wherein the base is included in a sufficient quantity to neutralize at least 75% of acid functional groups on the (meth)acrylic acid monomer.

15. The method of claim 1, wherein the amine-functional polysaccharide comprises polyglucosamine.

16-17. (canceled)

18. The method of claim 1, wherein the amine-functional alkoxysilane comprises 3-aminopropyltriethoxysilane, 3-aminopropyltrimethoxysilane, 3-trimethoxysilylpropyl diethylenetriamine, trimethoxysilylpropyl modified (polyethyleneimine), and/or dimethoxysilylmethylpropyl modified (polyethyleneimine).

19. The method of claim 1, wherein the amine-functional alkoxysilane comprises a reaction product of (i) polyethyleneimine, N-(3-aminopropyl)-1,4-butanediamine, N,N′-bis(3-aminopropyl)-1,4-butanediamine, N-(3-aminopropyl)-N′-[3-[(3-aminopropyl)amino]propyl]propane-1,3-diamine, 1,13-diamino-5,9-diazatridecane, triethylene tetraamine, diethylene triamine, and/or 1-(2-aminoethyl) piperazine with (ii) (3-glycidoxypropyl) trialkoxysilane, (3-glycidoxypropyl) bis(trimethylsiloxy)methylsilane, (3-glycidoxypropyl) dimethylethoxysilane, and/or (3-glycidoxypropyl) methyldiethoxysilane.

20-21. (canceled)

22. A treated microporous membrane prepared by the method of claim 1.

23. (canceled)

24. A method for treating a filtration device, wherein the filtration device is in the form of hollow fibers, a tubular device, a spiral wound filtration device or a pleated filtration device, the filtration device comprising a microporous membrane, the microporous membrane comprising an organic thermoplastic matrix; finely divided particulate, substantially water-insoluble inorganic filler distributed throughout the matrix; a network of interconnecting pores communicating throughout the microporous membrane, and an acid-functional acrylic layer on at least one surface of the microporous membrane, wherein the acid-functional acrylic layer is bonded to the filler via siloxane functional groups; the method comprising in sequence:
(1) contacting at least one surface of the acid-functional acrylic layer on the microporous membrane with a dispersion comprising an amine-functional polysaccharide dispersed in an aqueous medium containing an organic acid, to form a polysaccharide-treated membrane;
(2) contacting at least one surface of the polysaccharide-treated membrane formed in (1) with an aqueous acid; and
(3) contacting the polysaccharide-treated membrane with an amine-functional alkoxysilane to form a polysaccharide hydrogel layer on the membrane.

25. The method of claim 24, wherein the organic thermoplastic matrix comprises polyacrylonitrile, cellulose nitrate, polycarbonate, cellulose acetate, polytetrafluoroethylene (PTFE), polyamide, polyolefin, polyetherketone, polyvinylidene fluoride (PVDF), polysulfone, and/or polyethersulfone; and wherein the filler comprises silica, alumina, calcium oxide, zinc oxide, magnesium oxide, titanium oxide, and/or zirconium oxide.

26-28. (canceled)

29. The method of claim 24, wherein the amine-functional polysaccharide comprises polyglucosamine.

30-31. (canceled)

32. The method of claim 24, wherein the amine-functional alkoxysilane comprises 3-aminopropyltriethoxysilane, 3-aminopropyltrimethoxysilane, 3-trimethoxysilylpropyl)diethylenetriamine, trimethoxysilylpropyl modified (polyethyleneimine), and/or dimethoxysilylmethylpropyl modified (polyethyleneimine).

33. The method of claim 24, wherein the amine-functional alkoxysilane comprises a reaction product of (i) polyethyleneimine, N-(3-aminopropyl)-1,4-butanediamine, N,N′-bis(3-aminopropyl)-1,4-butanediamine, N-(3-aminopropyl)-N′-[3-[(3-aminopropyl)amino]propyl]propane-1,3-diamine, 1,13-diamino-5,9-diazatridecane, triethylene tetraamine, diethylene triamine, and/or 1-(2-aminoethyl)piperazine with (ii) (3-glycidoxypropyl) trialkoxysilane, (3-glycidoxypropyl) bis(trimethylsiloxy)methylsilane, (3-glycidoxypropyl) dimethylethoxysilane, and/or (3-glycidoxypropyl) methyldiethoxysilane.

34-36. (canceled)

37. A treated microporous membrane comprising:
(1) a microporous membrane comprising an organic thermoplastic matrix; finely divided particulate, substantially water-insoluble inorganic filler distributed throughout the matrix; and a network of interconnecting pores communicating throughout the microporous membrane, wherein the membrane is a component of a hollow fiber filtration device, a tubular filtration device, a spiral wound filtration device or a pleated filtration device;
(2) an acrylic layer on at least one surface of the microporous membrane, wherein the acrylic layer is formed from a mixture of vinyl monomers comprising: (i) a (meth)acrylic acid monomer and (ii) a silane-functional acrylic monomer, and wherein the acrylic layer is bonded to the filler via siloxane functional groups; and
(3) a hydrogel layer on at least one surface of the acrylic layer, wherein the hydrogel layer is formed from an amine-functional polysaccharide and an amine-functional alkoxysilane.

38. The treated microporous membrane claim 37, wherein the organic thermoplastic matrix comprises polyolefin, polyetherketone, polyvinylidene fluoride (PVDF), polysulfone, and/or polyethersulfone, and wherein the filler comprises silica, alumina, calcium oxide, zinc oxide, magnesium oxide, titanium oxide, and/or zirconium oxide.

39-40. (canceled)

41. The treated microporous membrane of claim 37, wherein the mixture of vinyl monomers further comprises (iii) N-vinylpyrrolidone.

42. The treated microporous membrane of claim 37, wherein the amine-functional polysaccharide comprises polyglucosamine.

43-47. (canceled)
